(19) United States
(12) Patent Application Publication
(10) Pub. No.: US 2015/0023010 A1
(43) Pub. Date: Jan. 22, 2015

(54) LED Lighting Panel

(71) Applicants: Dave Rozek, Westmont, IL (US); Manny Leon Lin, McHenry, IL (US)

(72) Inventors: Dave Rozek, Westmont, IL (US); Manny Leon Lin, McHenry, IL (US)

(21) Appl. No.: 13/943,955

(22) Filed: Jul. 17, 2013

(51) Int. Cl. F21K 99/00

(52) U.S. Cl. CPC F21K 9/175
USPC 362/225

(57) ABSTRACT

The invention relates to LED light panel adapted for use with a troffer style light fixture. The invention is also directed to a LED light retrofit kit to convert or replace existing troffer style light fixtures. The lighting panel includes a base member. The base member includes a first layer that is made up of a heat conductive material with a sufficient thermal conductivity to adequately dissipate heat generated by the lighting elements discussed below. The base member may also include a second layer that may provide structural support. A third layer base plate may also be included which may comprise an aluminum or copper sheet or other lightweight structurally strong heat conductive material. A power supply, which is connected to an energy source is provided and supplies electricity to at least one strip of LED lights, which are mounted with the first layer of the base member.

### FIELD OF THE INVENTION

The invention relates to LED light panel adapted for use with a troffer style light fixture. The invention is also directed to a LED light retrofit kit to convert or replace existing troffer style light fixtures.

### BACKGROUND OF THE INVENTION

A troffer style light fixture typically uses one or more fluorescent light tubes as a light source and can include magnetic or electronic ballasts. A troffer typically utilizes baffles and one or more polycarbonate covers, diffusers, or louvers for directing light as desired. A troffer is typically installed within a suspended ceiling grid system by replacing existing ceiling tiles with the troffers.

While commonly found in buildings, troffer style lights utilizing fluorescent light tubes have numerous shortcomings. These include, but are not limited to, the short usable life span of a typical fluorescent light tube, which is around one or two years. Because of this short life span, the costs associated with maintaining a large number of troffer light fixtures can be significant. This is especially true in large industrial or commercial buildings with numerous troffer style lights. Fluorescent light tubes also emit light in all directions, as opposed to being directed to a desired location, and thus lacking in lighting efficiency. Light fixtures with fluorescent light tubes also often emit a low humming noise that can be distracting or annoying.

One approach that has been attempted to ameliorate the problems with fluorescent light troffer fixtures is to substitute LED lights for the fluorescent lights. One benefit to LED lights over fluorescent lights is the lower energy required for LED lights. Another advantage is the greater life of LED lights as compared to fluorescent lights. However, a number of problems have been encountered with this approach as well.

One set of problems is a result of heat generated by the LED lights. Because of the heat generated by LED lights and the lack of a suitable means for heat dissipation, the LED lights tend to fail at a faster pace than would normally be experienced. In addition, the power supply for the LED's may also fail as a result of heat.

### SUMMARY OF THE INVENTION

The present invention is directed to a lighting panel that may be used as part of a retrofit kit for a troffer style light fixture. The lighting panel includes a base member. The base member includes a first layer that is made up of a heat conductive material with a sufficient thermal conductivity to adequately dissipate heat generated by the lighting elements discussed below. In a preferred embodiment, the base member is an aluminum based copper clad laminate, i.e., aluminum based CCL. In a preferred form, the base member comprises a first layer that is a circuit layer, a second layer that is a thermal insulation layer, and a third layer that is a metal substrate layer. Examples of preferred layers are described below.

In a preferred embodiment, the first layer has a thermal conductivity greater than about 100 W/mK. In some embodiments, the first layer may be the circuit layer and provide for the electrical connections in the form of etchings in the layer itself. For example, an etched copper sheet or foil, which has an approximate thermal conductivity of 401 W/mK, is utilized as a first layer. The copper layer or foil preferably has a thickness of approximately 35 μm (1.38×10⁻³ inches) to 280 μm (1.1×10⁻² inches).

In some embodiments, the base member may also include a second layer that may provide structural support. In this preferred embodiment, the second layer is comprised of a thermal conductive insulator material with low thermal resistance. For example, the second layer may comprise a fiberglass panel, epoxy glass cloth laminated board, PCB, or the like. In a preferred embodiment, the second layer may be comprised of FR4 fiberglass, IMS-H01, IMS-H02, or LED-0601. Preferably, the second layer has a thickness of approximately 0.003 inches (0.0762 mm) to 0.006 inches (0.1524 mm).

In some embodiments, a third layer base plate is included, to which the first and second layer are secured. The third layer in some embodiments may comprise an aluminum or copper sheet or other lightweight structurally strong heat conductive material. As such, it is preferred that the third layer provide both structural strength, as well as thermal conduction. For example, an 1100 alloy aluminum having an approximate thermal conductivity of 218 W/mK may be used. It is preferred that all or substantially all of a surface of the second layer is secured directly to the base plate to provide for the greatest amount of heat transfer by way of conduction. Additional layers may also be included to provide additional structural support or heat dissipation as desired.

A power supply is provided, and is preferably mounted with the base member. The power supply, which is sometimes referred to as a driver or a module, may be adapted to provide a constant voltage, or in a preferred embodiment, is configured to supply a constant current. The power supply is connected an energy source in any manner known in the art. Typically, and especially in retro-fit situations, the power supply is connected to the existing energy source such as the buildings electrical energy transmission system.

Electrically connected with the power supply is at least one strip of LED lights, or a light bar. The power supply preferably supplies a constant current to each LED strip or light bar. The LED light strip or strips are mounted with the first layer of the base member. A substantial portion, and preferably all, of the LED light strip is mounted to and in direct contact with the first layer. This direct contact provides for the greatest amount of heat dissipation through heat conduction since gaps between the LED strip and the heat conductive first layer provide margins of air, which have a low thermal conductivity and reduce the effective transfer of heat. The LED strips may be mechanically secured to the base member, such as with screws or the like. In a preferred embodiment, the LED strips may be secured to the base member by an adhesive that does not suffer from degradation as a result of heat, or by mechanical clips, or a combination thereof With regard to the adhesive, the choice would depend on factors such as the number of LED lights and heat anticipated to be generated. It is preferred that multiple LED light strips connected to the power supply are utilized.

In some embodiments, rather than have a LED light strip extend the majority of the length of the base member, a LED strip may extend from a first end of the base member only approximately half the length of the base member and end in the center section of the base member. In similar fashion, a second LED strip will extend from a second end of the base member towards the center and also end in the center section. Multiple pairs of such LED strips can be utilized as desired. In this embodiment, it is preferred that the power supply connects to the ends of the LED strips located in the center portion of the base member. This is because in a LED light strip, LED's downstream from the power source are typically dimmer than those farther upstream. In LED light strips of a length that would extend across the length of a typical troffer, the difference in light intensity from one end of the strip to another can be substantial. By arranging the LED strips as discussed, the overall length of each LED strip is shortened and the dimming effect minimized.

As discussed, in some embodiments the lighting panel may be used to retrofit existing troffer lighting fixtures to replace fluorescent lights. Rather than require replacement of the entire troffer, the lighting panel may be secured within an existing troffer lighting fixture without having to remove the entire fixture, thus, reducing costs. The lighting panel may be secured directly to the troffer by any known means, such as by simply bolting the lighting panel to the troffer. In many applications, such a retro-fit will be invisible to observers because a translucent or semi-transparent panel may be installed with the troffer.

In other embodiments, a diffuser can be secured over individual LED strips. In a preferred embodiment, a diffuser can be mounted with the base member by way of a clip member. The clip member may be the same mechanical clip member securing or assisting in the securement of the LED strip to the base member. Such a diffuser enhances both the function and aesthetics of the LED strips by spreading the light more evenly, and hiding individual LED's.

There has thus been outlined, rather broadly, some of the more important features of the invention in order that the detailed description thereof that follows may be better understood, and in order that the present contribution to the art may be better appreciated. There are, of course, additional features of the broader invention that have been described, and others that will be described hereinafter and which may form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a lighting panel according to a preferred embodiment of the present invention;

FIG. 2 is a plan view of the lighting panel of FIG. 1;

FIG. 3 is a cross sectional view of the base member according to a preferred embodiment;

FIG. 4 is a perspective view of an alternative preferred embodiment of the present invention;

FIG. 5 is a plan view of the lighting panel of FIG. 4;

FIG. 6 is an exploded view of a lighting panel retrofit kit according to a preferred embodiment of the present invention;

FIG. 7 is a plan view of an alternative lighting panel including individual LED light strip diffusers;

FIG. 8 is an enlarged partial top view of an individual LED light strip diffuser;

FIG. 8A is a cross sectional view of FIG. 8 along B-B;

FIG. 9 is a cross sectional view of an LED light strip and diffuser secured with mechanical clip member; and

FIG. 10 is a cross sectional view of an LED light strip without a diffuser secured with mechanical clip member.

### DETAILED DESCRIPTION OF THE PREFERRED EMBODIMENTS

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive. Also, in the drawings, the thickness of layers and regions are exaggerated for clarity. It will also be understood that when an element such as a layer, region or substrate is referred to as being “on” or “onto” another element, it may lie directly on the other element or intervening elements or layers may also be present. Like reference numerals refer to like elements throughout the specification.

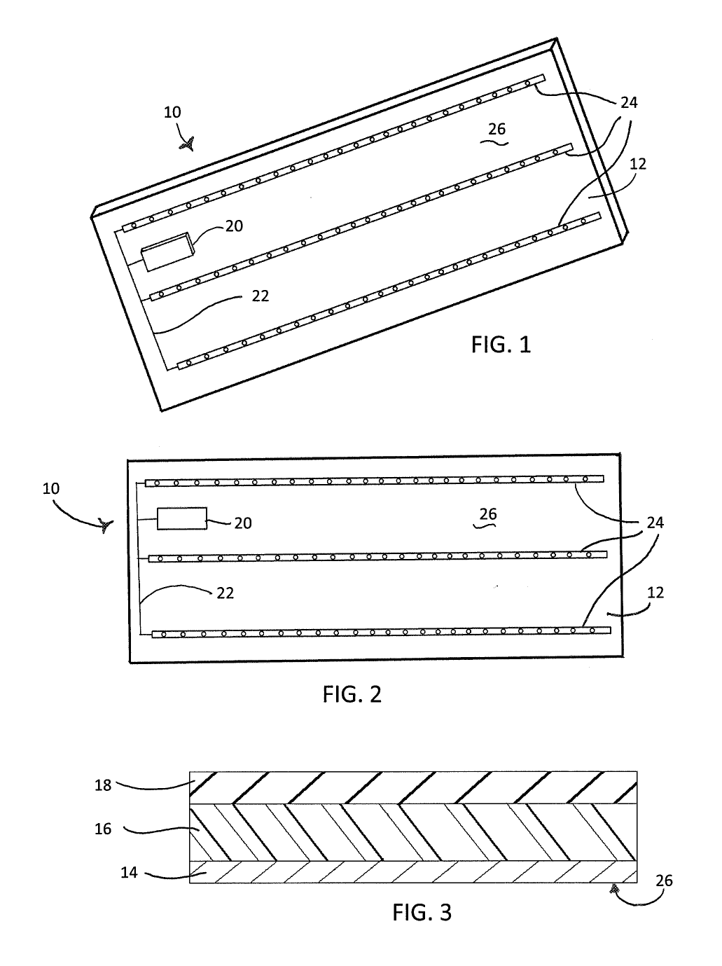

Referring to FIGS. 1-3, a preferred embodiment of a lighting panel 10 according to a preferred embodiment of the present invention is shown. Lighting panel 10 includes a base member 12. As shown in the cross section of FIG. 3, the base member 12 preferably comprises three layers, which for sake of ease of reference are referred to as first layer 14, second layer 16 and third layer 18. In this preferred embodiment, the base member 12 is an aluminum based copper clad laminate.

In the embodiment shown, the first layer comprises a copper sheet or foil. Copper is utilized due to its high thermal conductivity. For example, copper has an approximate thermal conductivity of 401 W/mK, is utilized as a first layer. This copper layer or foil is also preferably a circuit layer that provides for the electrical connections 22 from the power supply 20 to the LED strips 24. In order to provide adequate material to etch electrical connections 22, the copper layer or foil preferably has a thickness of approximately 35 μm (1.38×10⁻³ inches) to 280 μm (1.1×10⁻² inches). Alternatively, electrical connections such as wires can be mounted on the base member 12. In order to enhance the aesthetics of the light fixture, wires can be passed on the non-visible side of the base member 12.

As shown in FIG. 1, a plurality of LED strips 24 are mounted on base member 12. Different numbers, colors, lengths and intensities of LED strips can be included as desired. It is further contemplated that the LED strips that are activated can be varied so as to provide for a variety of colors or intensities. Also mounted on the base member 12 is power supply 20. This power supply 20 is preferably mounted on the first layer 14, but may be mounted on the third layer 18 so that it is hidden from view, or may be mounted to the troffer (not shown) itself.

The power supply 20, which may also be referred to as a driver or a module is preferably configured to supply a constant current. Power supply 20 is connected to a building's existing energy source in any manner known in the art. Power supply 20 may also be connected to a battery or any other source of electricity.

A constant current power supply 20 provides for the additional benefit of even distribution of power to each of the LED's in the LED light strip. In some situations, such as a long light strip, LED's further downstream from the power supply may be dimmer than LED's closer to the power supply where the power supply supplies a constant voltage. In some situations, it is not necessary to utilize a constant current power supply, and a constant voltage power supply is sufficient.

Referring to FIGS. 1 and 2, the LED light strips 24 are mounted on the surface 26 of the first layer 14 of the base member 12. It is preferred that each LED light strip 24 is fully in direct contact with the surface 26 of the first layer 14 in order to provide for the greatest amount of heat dissipation through heat conduction. Air gaps between the LED light strips 24 and the surface 26 reduce the overall effective transfer of heat due to the low thermal conductivity of air. Suitable means for securing the LED strips to the base member are known in the art, and depend on what LED lights are to be used.

Referring to FIG. 2, first layer 14 is mounted directly to second layer 16 through any means known in the art. Second layer 16 preferably comprises a thermal conductive insulator material with low thermal resistance. In a preferred embodiment, the second layer 16 is a dielectric layer and may comprise FR4 fiberglass, IMS-H01, IMS-H02, or LED-0601. Preferably, the second layer has a thickness of approximately 0.003 inches (0.0762 mm) to 0.006 inches (0.1524 mm).

Second layer 16 is mounted with third layer 18. The third layer 18 comprises a substrate for the first and second layers 14 and 16. In a preferred form, the third layer base plate 18 is comprised of aluminum or copper, however, other lightweight structurally strong heat conductive materials can be used. By way of example, an 1100 alloy aluminum having an approximate thermal conductivity of 218 W/mK may be used. Although not shown, it is contemplated that additional layers may also be included to provide additional structural support or heat dissipation as desired.

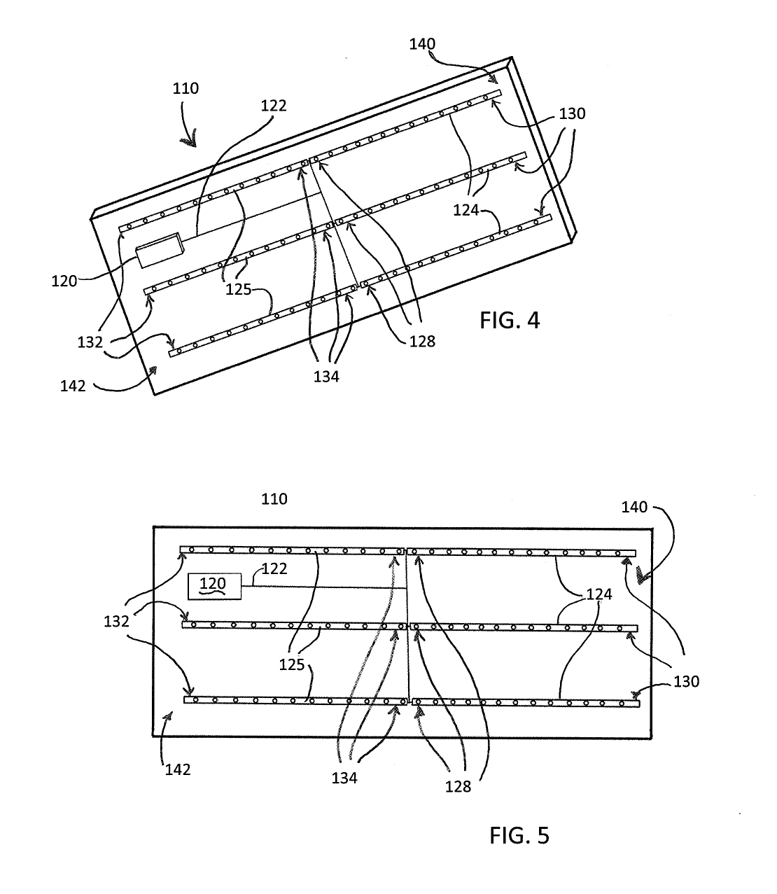

A second preferred embodiment is described with respect to FIGS. 4 and 5. In this preferred embodiment, the various layers of the lighting panel 110 are as described with the first embodiment, see e.g., FIG. 3. In this embodiment, rather than have a LED light strip extend the majority of the length of the base member, the plurality of LED strips may extend only approximately half the length of the base member 112. For sake of reference, a first set of LED strips 124 and a second set of LED strips 125 are described. The first set of LED strips 124 is connected to power supply 120 via electrical connections 122 at a first end 128 positioned on a central portion 138 of base member 112. The first set of LED strips 124 extends towards a second end 142 of the base member 112. The second set of LED strips 125 is also connected to power supply 120 via electrical connections 122 at a second end 134 thereof. The second end 134 of the second set of LED strips 125 also extends from the central portion 138 of the base member 112 towards a first end 140 of base member 112.

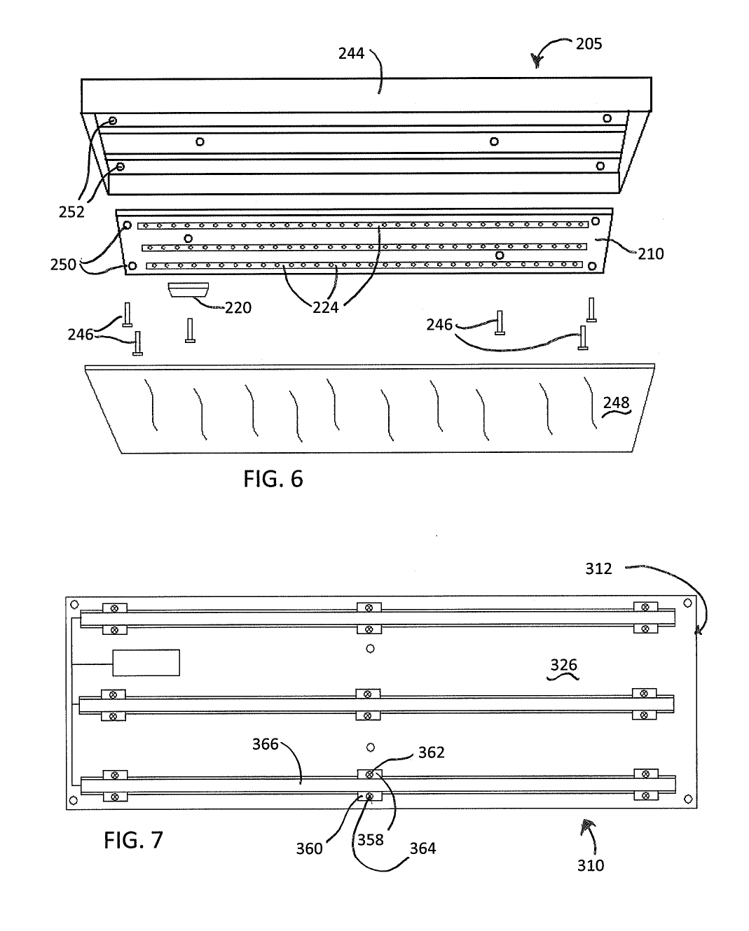

Lighting panels such as described may be used to retrofit existing troffer lighting fixtures to replace fluorescent lights. This provides for a substantial cost savings in that rather than require replacement of the entire troffer, the lighting panel may be secured within an existing troffer lighting fixture without having to remove the entire fixture. Referring to FIG. 6, a preferred embodiment of a lighting retrofit kit 205 is shown. The lighting panel 210 may be secured directly to the troffer 244 by any known means, such as by simply bolting the lighting panel 210 to the troffer 244 with a plurality of bolts 246. For example, bolts 246 may be guided through and engage apertures 250, as well as apertures 252 in the troffer 244.

In this embodiment, power supply 220 is shown as not being directly mounted to the base member 212 with LED strips 224. As discussed above, the power supply 220 may be mounted to the base member 212 on either the top or bottom, or to the troffer 244. Any suitable configuration for the electrical connections, such as discussed above may also be used.

In many applications, such a retro-fit will be invisible to observers because a diffuser 248, such as a translucent or semi-transparent or frosted panel may be installed with the troffer. In some applications, such as where a panel 248 is not used, other securement members as are known in the art may be used that would not be visible or are aesthetically pleasant.

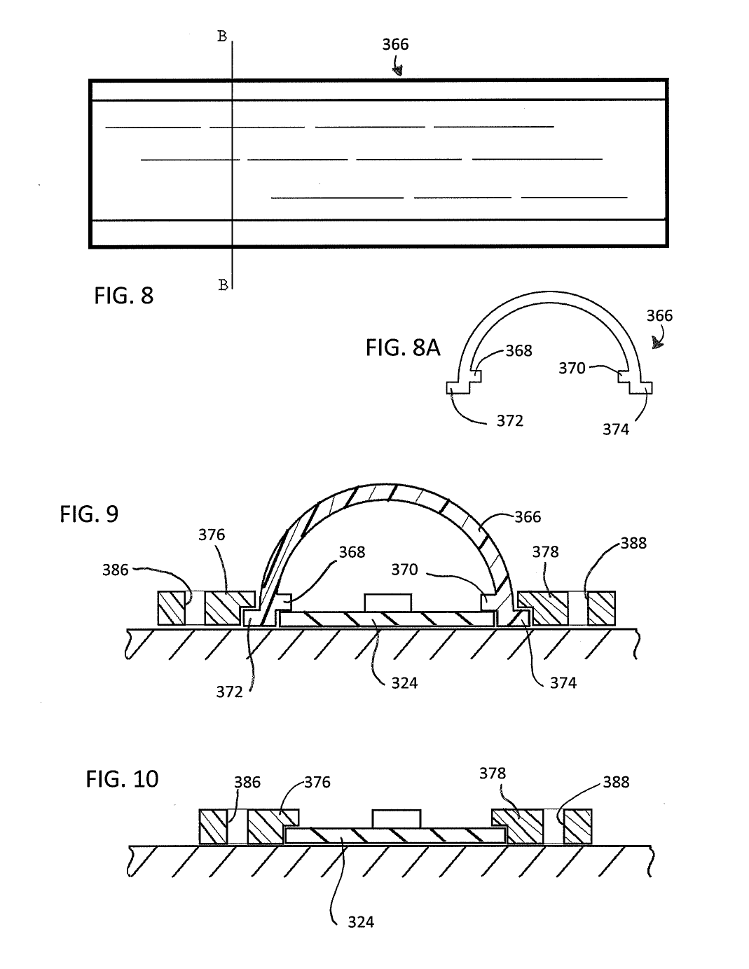

Referring to FIGS. 7-9, another preferred feature of the present invention is described. Unlike fluorescent lights, LED lights emit a focused beam of light. Diffusers, such as described above are often used to soften the light emitted. In some cases, a troffer may not include a diffuser for the overall light fixture. Instead, it another possible embodiment is to include individual diffuser tubes for the LED strips. Lighting panel 310 depicts a base member 312 with three LED strips (not shown) mounted on the surface 326. Also mounted with the base member 312 are a plurality of clip members, such as clips 358 and 360. Each of the clips is removably fastened to the base member 312, such as with screws 362 and 364. A plurality of diffuser tubes, such as diffuser tube 366 is mounted with the base member 312 over the LED strips. A preferred diffuser tube 366 is shown in FIG. 8. As shown in FIG. 8A, the diffuser tube 366 comprises what is a generally half of a cylinder with detents 368, 370, 372 and 374 formed at the ends. Other shapes of diffuser tubes may be utilized depending on the lighting application.

Referring to FIG. 9, prior to installation of the lighting panel, diffuser tube 366 is positioned over LED strip 324. Clips 358 and 360 are positioned such that shoulder 376 and shoulder 378 engage detents 372 and 374, respectively. Although not shown, screws 362 and 364 are then installed within apertures 386 and 388 to hold clips 358 and 360 in place. As shown, in this preferred embodiment, detents 368 and 370 engage LED strip 324 and support or provide added support for the mounting of the LED strip. As shown in FIG. 7, multiple pairs of clip members may be used for each LED strip. The use of such clip members can be instead of or in addition to the use of an adhesive or other mechanical means for securing the LED strips.

FIG. 10 shows a variant on FIG. 9, wherein a diffuser tube is not utilized. In this case, clips 358 and 360 are positioned such that shoulders 376 and 378 engage portions of the edge of the LED strip 324. Screws, which are not shown, are installed within apertures 386 and 388.

While the invention has been taught with specific reference to these embodiments, someone skilled in the art will recognize that changes can be made in form and detail without departing from the spirit and the scope of the invention. The invention should therefore be limited only by the scope of the human imagination. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A lighting panel assembly comprising:
a base member, the base member comprising a first layer, the first layer comprising a heat conductive material having thermal conductivity greater than about 150 W/mK;
a power supply connectable to an energy source;
at least one LED strip mounted with the first layer of the base member, the LED strip electrically connected to the power supply, and the LED strip is mounted with the first layer such that at least a substantial portion of the LED strip is in direct thermal contact with the first layer and heat generated by the LED strip is transferred by way of conduction to the first layer; and
at least one electrical connection between the power supply and the LED strip.

2. The lighting panel of claim 1, wherein the power supply provides a constant current to the at least one LED strip.

3. The lighting panel of claim 1, wherein the power supply provides a constant voltage to the at least one LED strip.

4. The lighting panel of claim 1, wherein the first layer is comprised of copper.

5. The lighting panel of claim 1, wherein the first layer is comprised of a material having a thermal conductivity greater than 300 W/mk.

6. The lighting panel of claim 1, wherein the first layer is comprised of copper, a second layer is a sheet comprising a fiberglass panel, and a third layer is a base plate, wherein a substantial portion of the second layer is directly mounted with the base plate.

7. The lighting panel of claim 6, wherein the base plate comprises sheet comprising aluminum.

8. The lighting panel of claim 1, wherein the electrical connection comprises etchings formed in the first layer.

9. The lighting panel of claim 1, wherein at least two LED strips are mounted with the first layer, one of the at least two LED strips mounted on a first portion of the first layer, and a second of the at least two LED strips mounted on a second portion of the first layer, the second portion being longitudinally spaced from the first portion.

10. The lighting panel of claim 9, wherein the LED strip mounted on the first portion extends from a center portion of the panel towards a first end of the panel, the LED strip mounted on the second portion extends from the center portion towards a second end of the panel opposed to the first end, and the electrical connection connects to each of the LED strips at the center portion of the panel.

11. A lighting retrofit kit for a troffer style light fixture, the kit comprising:
a base member adapted to be secured within an existing troffer light fixture by a plurality of securement members, the base member comprising a first layer, the first layer comprising a heat conductive material having thermal conductivity greater than about 100 W/mK;
a power supply connectable to an energy source;
at least one LED strip mounted with the first layer of the base member, the LED strip electrically connected to the power supply, and the LED strip is mounted with the first layer such that a substantial portion of the LED strip is in direct thermal contact with the first layer and heat generated by the LED strip is transferred by way of conduction to the first layer; and
at least one electrical connection between the power supply and the LED strip, the electrical connection being mounted with the base member.

12. The lighting panel of claim 11, wherein the power supply provides a constant current to the at least one LED strip.

13. The lighting panel of claim 11, wherein the first layer is comprised of copper.

14. The lighting panel of claim 11, wherein the first layer is comprised of a material having a thermal conductivity greater than 300 W/mk.

15. The lighting panel of claim 11, wherein the first layer is comprised of copper, a second layer is a sheet comprising a fiberglass panel, and a third layer is a base plate, wherein a substantial portion of the second layer is directly mounted with the base plate.

16. The lighting panel of claim 15, wherein the base plate comprises sheet comprising aluminum.

17. The lighting panel of claim 11, wherein the electrical connection comprises etchings formed in the first layer.

18. The lighting panel of claim 11, wherein at least two LED strips are mounted with the first layer, one of the at least two LED strips mounted on a first portion of the first layer, and a second of the at least two LED strips mounted on a second portion of the first layer, the second portion being longitudinally spaced from the first portion.

19. The lighting panel of claim 18, wherein the LED strip mounted on the first portion extends from a center portion of the panel towards a first end of the panel, the LED strip mounted on the second portion extends from the center portion towards a second end of the panel opposed to the first end, and the electrical connection connects to each of the LED strips at the center portion of the panel.

20. The lighting retrofit kit of claim 11, wherein the plurality of securement members comprises a plurality of bolts adapted to secure to the base member to the troffer style light fixture.
